(19) United States
(12) Patent Application Publication
(10) Pub. No.: US 2023/0244305 A1
(43) Pub. Date: Aug. 3, 2023

(54) ACTIVE INTERACTIVE NAVIGATION SYSTEM AND ACTIVE INTERACTIVE NAVIGATION METHOD

(71) Applicant: Industrial Technology Research Institute, Hsinchu (TW)

(72) Inventors: Te-Chih Liu, Taoyuan City (TW); Ting-Hsun Cheng, Chiayi County (TW); Yu-Ju Chao, Hsinchu County (TW); Jian-Lung Chen, Taoyuan City (TW); Yu-Hsin Lin, Miaoli County (TW)

(73) Assignee: Industrial Technology Research Institute, Hsinchu (TW)

(21) Appl. No.: 18/150,197

(22) Filed: Jan. 5, 2023

Related U.S. Application Data
(60) Provisional application No. 63/296,486, filed on Jan. 5, 2022.

(51) Int. Cl. G06F 3/01; G06T 7/20; G06T 7/73; G06V 40/16; G06V 10/26; G06V 10/75

(52) U.S. Cl. CPC G06F 3/012; G06T 7/20; G06T 7/73; G06V 10/26; G06V 10/751; G06V 40/168; G06V 40/172; G06T 2207/20021; G06T 2207/30201; G06V 2201/02

(57) ABSTRACT

An active interactive navigation system includes a display device, a target object image capturing device, a user image capturing device, and a processing device. The target object image capturing device captures a dynamic object image. The user image capturing device obtains a user image. The processing device recognizes and selects a service user from the user image and captures a facial feature of the service user. If the facial feature matches facial feature points, the processing device detects a line of sight of the service user and accordingly recognizes a target object watched by the service user, generates face position three-dimensional coordinates corresponding to the service user, position three-dimensional coordinates corresponding to the target object, and depth and width information, accordingly calculates a cross-point position where the line of sight passes through the display device, and display virtual information of the target object on the cross-point position of the display device.

### CROSS REFERENCE TO RELATED APPLICATION

This application claims the priority benefit of U.S. Provisional Application Serial No. 63/296,486, filed on Jan. 5, 2022. The entirety of the above-mentioned patent application is hereby incorporated by reference herein and made a part of this specification.

### TECHNICAL FIELD

The disclosure relates to an active interactive navigation technique, and in particular, relates to an active interactive navigation system and an active interactive navigation method.

### BACKGROUND

With the development of image processing technology and spatial positioning technology, the application of transparent displays has attracted increasing attention. In this type of technology, a display device is allowed to be matched with dynamic objects and provided with virtual related information, and an interactive experience is generated according to the needs of users, so that the information is intuitively presented. Further, the virtual information associated with the dynamic object may be displayed on a specific position of the transparent display device, so that the user can simultaneously view the dynamic objects as well as the virtual information superimposed on the dynamic objects through the transparent display device.

However, when the user is far away from the display device, the device for capturing the user’s image may not be able to determine the line of sight of the user. As such, the system will not be able to determine the dynamic object that the user is watching, so the system cannot display the correct virtual information on the display device and cannot superimpose the virtual information corresponding to the dynamic object that the user is watching on the dynamic object.

In addition, when the system detects that multiple users are viewing the dynamic objects at the same time, since the line of sight directions of the users are different, the system cannot determine which virtual information related to the dynamic objects to display. As such, the interactive navigation system cannot present the virtual information corresponding to the dynamic objects that the users are viewing, so the viewers may have difficulty viewing the virtual information and may not enjoy a comfortable viewing experience.

### SUMMARY

The disclosure provides an active interactive navigation system including a light-transmittable display device, a target object image capturing device, a user image capturing device, and a processing device. The light-transmittable display device is disposed between at least one user and a plurality of dynamic objects. The target object image capturing device is coupled to the display device and is configured to obtain a dynamic object image. The user image capturing device is coupled to the display device and is configured to obtain a user image. The processing device is coupled to the display device. The processing device is configured to recognize the dynamic objects in the dynamic object image and tracks the dynamic objects. The processing device is further configured to recognize the at least one user and select a service user in the user image, capture a facial feature of the service user, determine whether the facial feature matches a plurality of facial feature points. If the facial feature matches the facial feature points, the processing device detects a line of sight of the service user. The line of sight passes through the display device to watch a target object among the dynamic objects. If the facial feature does not match the facial feature points, the processing device performs image cutting to cut the user image into a plurality of images to be recognized. The user image capturing device performs user recognition on each of the images to be recognized. The processing device is further configured to recognize the target object watched by the service user according to the line of sight, generate face position three-dimensional coordinates corresponding to the service user, position three-dimensional coordinates corresponding to the target object, and depth and width information of the target object, accordingly calculate a cross-point position where the line of sight passes through the display device, and display virtual information corresponding to the target object on the cross-point position of the display device.

The disclosure further provides an active interactive navigation method adapted to an active interactive navigation system including a light-transmittable display device, a target object image capturing device, a user image capturing device, and a processing device. The display device is disposed between at least one user and a plurality of dynamic objects. The processing device is configured to execute the active interactive navigation method. The active interactive navigation method includes the following steps. The target object image capturing device captures a dynamic object image. The dynamic objects in the dynamic object image are recognized, and the dynamic objects are tracked. The user image capturing device obtains a user image. The at least one user in the user image is recognized, and a service user is selected. A facial feature of the service user is captured, and it is determined whether the facial feature matches a plurality of facial feature points. If the facial feature matches the facial feature points, a line of sight of the service user is detected. The line of sight passes through the display device to watch a target object among the dynamic objects. If the facial feature does not match the facial feature points, image cutting is performed to cut the user image into a plurality of images to be recognized. User recognition is performed on each of the images to be recognized. The target object watched by the service user is recognized according to the line of sight. Face position three-dimensional coordinates corresponding to the service user, position three-dimensional coordinates corresponding to the target object, and depth and width information of the target object are generated. A cross-point position where the line of sight passes through the display device is accordingly calculated. Virtual information corresponding to the target object is displayed on the cross-point position of the display device.

The disclosure provides an active interactive navigation system including a light-transmittable display device, a target object image capturing device, a user image capturing device, and a processing device. The light-transmittable display device is disposed between at least one user and a plurality of dynamic objects. The target object image capturing device is coupled to the display device and is configured to obtain a dynamic object image. The user image capturing device is coupled to the display device and is configured to obtain a user image. The processing device is coupled to the display device. The processing device is configured to recognize the dynamic objects in the dynamic object image and tracks the dynamic objects. The processing device is further configured to recognize the at least one user in the user image, select a service user according to a service area range, and detect a line of sight of the service user. The service area range has initial dimensions, and the line of sight passes through the display device to watch a target object among the dynamic objects. The processing device is further configured to recognize the target object watched by the service user according to the line of sight, generate face position three-dimensional coordinates corresponding to the service user, position three-dimensional coordinates corresponding to the target object, and depth and width information of the target object, accordingly calculate a cross-point position where the line of sight passes through the display device, and display virtual information corresponding to the target object on the cross-point position of the display device.

To sum up, in the active interactive navigation system and the active interactive navigation method provided by the disclosure, the line of sight direction of the user is tracked and viewed at real time, the moving target object is stably tracked, and the virtual information corresponding to the target object is actively displayed. In this way, high-precision augmented reality information and a comfortable non-contact interactive experience are provided. In the disclosure, internal and external perception recognition, virtual-reality fusion, and system virtual-reality fusion may also be integrated to match the calculation core. The angle of the tourist’s line of sight is actively recognized by the inner perception and is then recognized with the AI target object of outer perception, and the application of augmented reality is thus achieved. In addition, in the disclosure, the algorithm for correcting the display position in virtual-reality fusion is optimized for the implementation of the offset correction method, so that the face recognition of far users is improved, and the priority of the service users is filtered. In this way, the problem of manpower shortage can be solved, and an interactive experience of zero-distance transmission of knowledge and information can be created.

### BRIEF DESCRIPTION OF THE DRAWINGS

FIG. 1 is a block diagram illustrating an active interactive navigation system according to an exemplary embodiment of the disclosure.

FIG. 2 is a schematic diagram illustrating the active interactive navigation system according to an exemplary embodiment of the disclosure.

FIG. 3A is a schematic diagram illustrating implementation of image cutting to recognize a far user according to an exemplary embodiment of the disclosure.

FIG. 3B is a schematic diagram illustrating the implementation of image cutting to recognize the far user according to an exemplary embodiment of the disclosure.

FIG. 3C is a schematic diagram illustrating the implementation of image cutting to recognize the far user according to an exemplary embodiment of the disclosure.

FIG. 3D is a schematic diagram illustrating the implementation of image cutting to recognize the far user according to an exemplary embodiment of the disclosure.

FIG. 3E is a schematic diagram illustrating the implementation of image cutting to recognize the far user according to an exemplary embodiment of the disclosure.

FIG. 4 is a schematic diagram illustrating selection of a service user by the active interactive navigation system according to an exemplary embodiment of the disclosure.

FIG. 5 is a schematic diagram illustrating adjustment of a service area range according to an exemplary embodiment of the disclosure.

FIG. 6 is a flow chart illustrating an active interactive navigation method according to an exemplary embodiment of the disclosure.

FIG. 7 is a flow chart illustrating the active interactive navigation method according to an exemplary embodiment of the disclosure.

### DETAILED DESCRIPTION OF DISCLOSURED EMBODIMENTS

Several exemplary embodiments of the disclosure are described in detail below accompanying with figures. In terms of the reference numerals used in the following description, the same reference numerals in different figures should be considered as the same or the like elements. These exemplary embodiments are only a portion of the disclosure, which do not present all the embodiments of the disclosure. More specifically, these exemplary embodiments serve as examples of the method, device, and system fall within the scope of the claims of the disclosure.

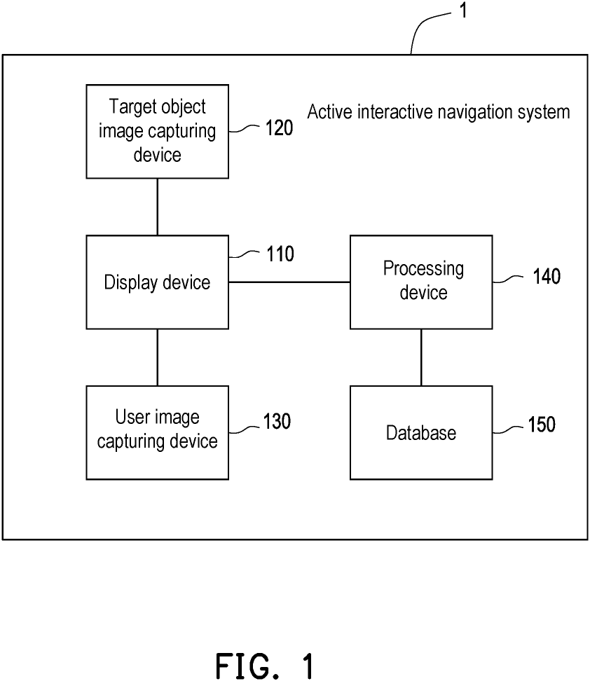

FIG. 1 is a block diagram illustrating an active interactive navigation system 1 according to an exemplary embodiment of the disclosure. First, FIG. 1 introduces the various components and arrangement relationships in the active interactive navigation system 1, and the detailed functions are to be disclosed together with the flow charts in the following embodiments.

With reference to FIG. 1, the active interactive navigation system 1 provided by the disclosure includes a light-transmittable display device 110, a target object image capturing device 120, a user image capturing device 130, a processing device 140, and a database 150. The processing device 140 may be connected to the display device 110, the target object image capturing device 120, the user image capturing device 130, and the database 150 through wireless, wired, or electrical connection.

The display device 110 is disposed between at least one user and a plurality of dynamic objects. In practice, the display device 110 may be a transmissive light-transmittable display, such as a liquid crystal display (LCD), a field sequential color LCD, a light emitting diode (LED) display, an electrowetting display, or a transmissive light-transmittable display, or may be a projection-type light-transmissible display.

The target object image capturing device 120 and the user image capturing device 130 may both be coupled to the display device 130 and disposed on the display device 110, or may both be coupled to the display device 130 only and are separately disposed near the display device 110. Image capturing directions of the object image capturing device 120 and the user image capturing device 130 face different directions of the display device 110. That is, the image capturing direction of the target object image capturing device 120 faces the direction with the dynamic objects, and the image capturing direction of the user image capturing device 130 faces the direction of the at least one user in an implementation area. The target object image capturing device 120 is configured to obtain a dynamic object image of the dynamic objects, and the user image capturing device 130 is configured to obtain a user image of the at least one user in the implementation area.

In practice, the target object image capturing device 120 includes an RGB image sensing module, a depth sensing module, an inertial sensing module, and a GPS positioning sensing module. The target object image capturing device 120 may perform image recognition and positioning on the dynamic objects through the RGB image sensing module or through the RGB image sensing module together with the depth sensing module, the inertial sensing module, or the GPS positioning sensing module. The RGB image sensing module may include a visible light sensor or an invisible light sensor such as an infrared sensor. Further, the target object image capturing device 120 may be, for example, an optical locator to perform optical spatial positioning on the dynamic objects. As long as it is a device or a combination thereof capable of positioning location information of the dynamic objects, it all belongs to the scope of the target object image capturing device 120.

The user image capturing device 130 includes an RGB image sensing module, a depth sensing module, an inertial sensing module, and a GPS positioning sensing module. The user image capturing device 130 may perform image recognition and positioning on the at least one user through the RGB image sensing module or through the RGB image sensing module together with the depth sensing module, the inertial sensing module, or the GPS positioning sensing module. The RGB image sensing module may include a visible light sensor or an invisible light sensor such as an infrared sensor. As long as it is a device or a combination thereof capable of positioning location information of the at least one user, it all belongs to the scope of the user image capturing device 130.

In the embodiments of the disclosure, each of the abovementioned image capturing devices may be used to capture an image and may include a camera lens with a lens and a photosensitive element. The abovementioned depth sensor may be used to detect depth information, and such detection may be achieved by using the active depth sensing technology and the passive depth sensing technology. In the active depth sensing technology, the depth information may be calculated by actively sending out light sources, infrared rays, ultrasonic waves, lasers, etc. as signals with the time-of-flight technology. In the passive depth sensing technology, two images at the front may be captured by two image capturing devices with different viewing angles, so as to calculate the depth information by using the viewing difference between the two images.

The processing device 140 is configured to control the operation of the active interactive navigation system 1 and may include a memory and a processor (not shown in FIG. 1). The memory, for example, may be a fixed or a movable random access memory (RAM) in any form, a read-only memory (ROM), a flash memory, a hard disc or other similar devices, an integrated circuit, or a combination of the foregoing devices. The processor may be, for example, a central processing unit (CPU), an application processor (AP), a programmable microprocessor for general or special use, a digital signal processor (DSP), an image signal processor (ISP), a graphics processing unit (GPU) or any other similar devices, an integrated circuit, or a combination of the foregoing devices.

The database 150 is coupled to the processing device 140 and is configured to store data provided to the processing device 140 for feature comparison. The database 150 may be any type of memory medium providing stored data or programs and may be, for example, a fixed or a movable random access memory (RAM) in any form, a read-only memory (ROM), a flash memory, a hard disc or other similar devices, an integrated circuit, or a combination of the foregoing devices.

In this embodiment, the processing device 140 may be a computer device built into the display device 110 or connected to the display device 110. The target object image capturing device 120 and the user image capturing device 130 may be disposed in an area to which the active interactive navigation system 1 belongs on opposite sides of the display device 110, are configured to position the user and the dynamic objects, and transmit information to the processing device 140 through communication interfaces of their own in a wired or wireless manner. In some embodiments, each of the target object image capturing device 120 and the user image capturing device 130 may also have a processor and a memory and may be equipped with computing capabilities for object recognition and object tracking based on image data.

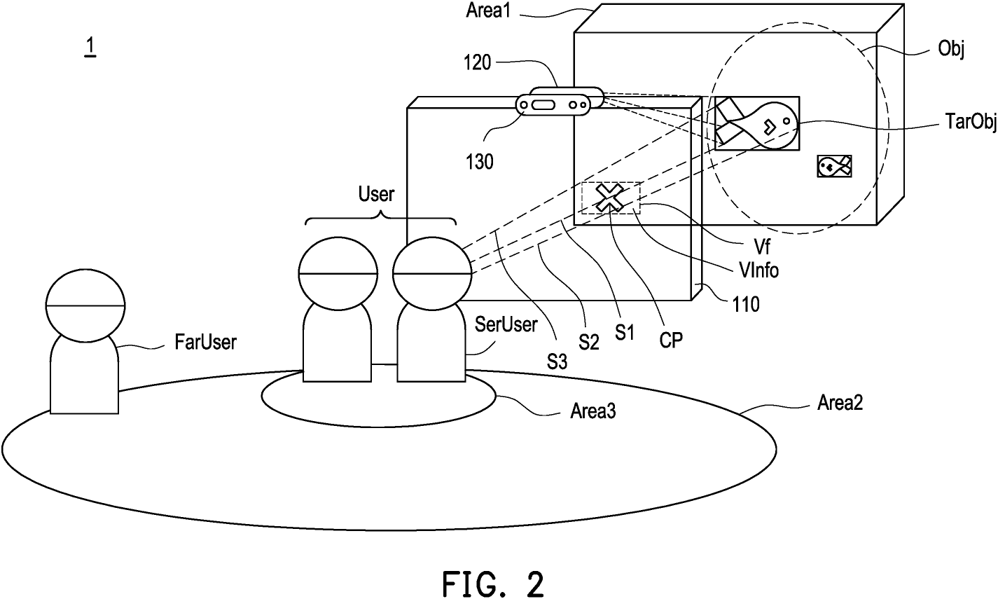

FIG. 2 is a schematic diagram illustrating the active interactive navigation system 1 according to an exemplary embodiment of the disclosure. With reference to FIG. 2, one side of the display device 110 faces an object area Area1, and the other side of the display device 110 faces an implementation area Area2. Both the target object image capturing device 120 and the user image capturing device 130 are coupled to the display device 110. The image capturing direction of the target object image capturing device 120 faces the object areaArea1, and the image capturing direction of the user image capturing device 130 faces the implementation area Area2. Herein, the implementation area Area2 includes a service area Area3, and a user who wants to view virtual information corresponding to a dynamic object Obj through the display device 110 may stand in the service area Area3.

The dynamic object Obj is located in the object area Area1. The dynamic object Obj shown in FIG. 2 is only for illustration, and only one dynamic object Obj may be provided, or a plurality of dynamic objects may be provided. A user User viewing the dynamic object Obj is located in the implementation area Area2 or the service area Area3. The user User shown in FIG. 2 is only for illustration, and only one user may be present, or several users may be present.

The user User may view the dynamic object Obj located in the object area Area1 through the display device 110 in the service area Area3. In some embodiments, the target object image capturing device 120 is configured to obtain the dynamic object image of the dynamic object Obj. The processing device 140 recognizes spatial position information of the dynamic object Obj in the dynamic object image and tracks the dynamic object Obj. The user image capturing device 130 is configured to obtain the user image of the user User. The processing device 140 recognizes the spatial position information of the user User in the user image and selects a service user SerUser.

When the user User is standing in the service area Area3, the user User accounts for a moderate proportion in the user image obtained by the user image capturing device 130, and the processing device 140 may recognize the user User and select the service user SerUser through a common face recognition method. However, if the user User is not standing in the service area Area3 but is standing in the implementation area Area2 instead, the user is then called as a far user FarUser, and the user image capturing device 130 may still obtain the user image by photographing the far user FarUser. Since the proportion of the far user FarUser in the user image is considerably small, the processing device 140 cannot be able to recognize the far user FarUser through a general face recognition method and cannot select the service user SerUser either from the far user FarUser.

In an embodiment, the database 150 stores a plurality of facial feature points. After the processing device 140 recognizes the user User and selects the service user SerUser in the user image, the processing device 140 captures a facial feature of the service user SerUser and determines whether the facial feature matches the plurality of facial feature points. The facial feature herein refers to one of the features on the face such as eyes, nose, mouth, eyebrows, and face shape. Generally, there are 468 facial feature points, and once the captured facial feature matches the predetermined facial feature points, user recognition may be effectively performed.

If the processing device 140 determines that the facial feature matches the facial feature points, it means that the user User accounts for a moderate proportion in the user images obtained by the user image capturing device 130, and the processing device 140 may recognize the user User and select the service user SerUser through a common face recognition method. Herein, the processing device 140 calculates a face position of the service user SerUser by using the facial feature points to detect a line of sight direction of a line of sight S1 of the service user SerUser and generates a number (ID) corresponding to the service user SerUser and face position three-dimensional coordinates (xᵤ, yᵤ, zᵤ).

The line of sight S1 indicates that the eyes focus on a portion of the target object TarObj when the line of sight of the service user SerUser passes through the display device 110 to watch a target object TarObj among a plurality of dynamic objects Obj. In FIG. 2, a line of sight S2 or a line of sight S3 indicates that the eyes focus on other portions of the target object TarObj when the line of sight of the service user SerUser passes through the display device 110 to watch the target object TarObj among the plurality of dynamic objects Obj.

If the processing device 140 determines that the facial feature does not match the facial feature points, it may be that no user is standing in the implementation area Area2 nor the service area Area3, it may be that a far user FarUser is standing in the implementation area Area2, or it may be that the user image capturing device 130 is required to be subjected to a light-supplementing mechanism to improve the clarity of the user image. When detecting that a far user FarUser is present in the implementation area Area2, the processing device 140 may first perform image cutting to cut the user image into a plurality of images to be recognized. Herein, at least one of the images to be recognized includes the far user FarUser. In this way, since the proportion of the far user FarUser in this one of the images to be recognized may increase, it is beneficial for the processing device 140 to perform user recognition on the far user FarUser, and recognize the spatial position information of the far user FarUser among the images to be recognized. The processing device 140 performs user recognition on each of the of images to be recognized, captures the facial feature of the far user FarUser from the image to be recognized with the far user FarUser, and calculates the face position and the line of sight direction of the line of sight S1 of the service user SerUser in the far user FarUser by using the facial feature points.

However, most of the general image cutting techniques use a plurality of cutting lines to directly cut the image into a plurality of small images. If the user image provided in the disclosure is cut by using a general image cutting technique, the cutting lines are likely to just fall on the face of the far user FarUser in the user image. In this way, the processing device 140 may not be able to effectively recognize the far user FarUser.

Therefore, in an embodiment of the disclosure, when performing image cutting, the processing device 140 temporarily divides the user image into a plurality of temporary image blocks through temporary cutting lines and then cuts the user image into a plurality of images to be recognized based on the temporary image blocks. Further, an overlapping region is present between one of the images to be recognized and another adjacent one, and the “adjacent” mentioned herein may be vertical, horizontal, or diagonal adjacent. The overlapping region is present to ensure that the face of the far user FarUser in the user image may be completely kept in the images to be recognized. How the processing device 140 in the disclosure performs image cutting to recognize the far user FarUser is going to be described in detail below.

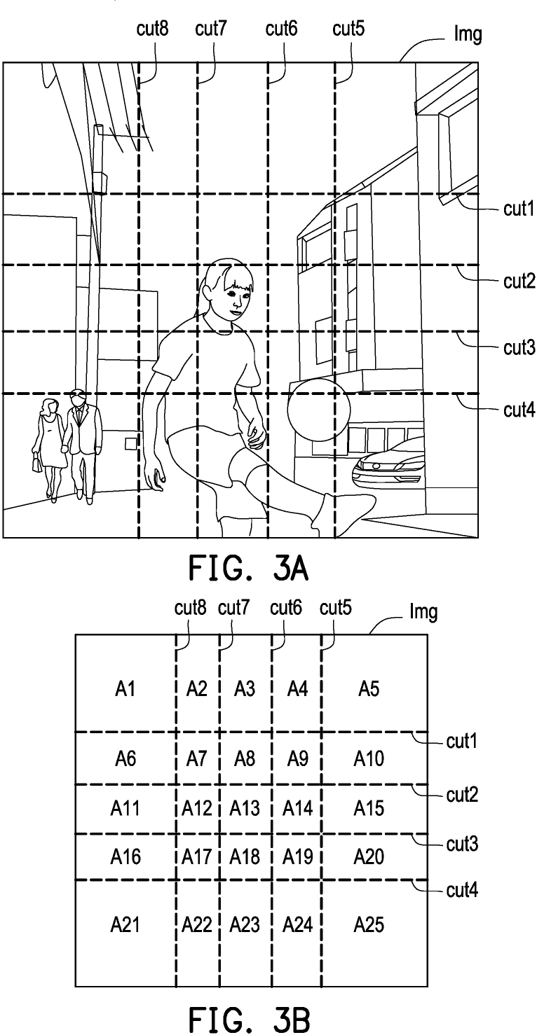

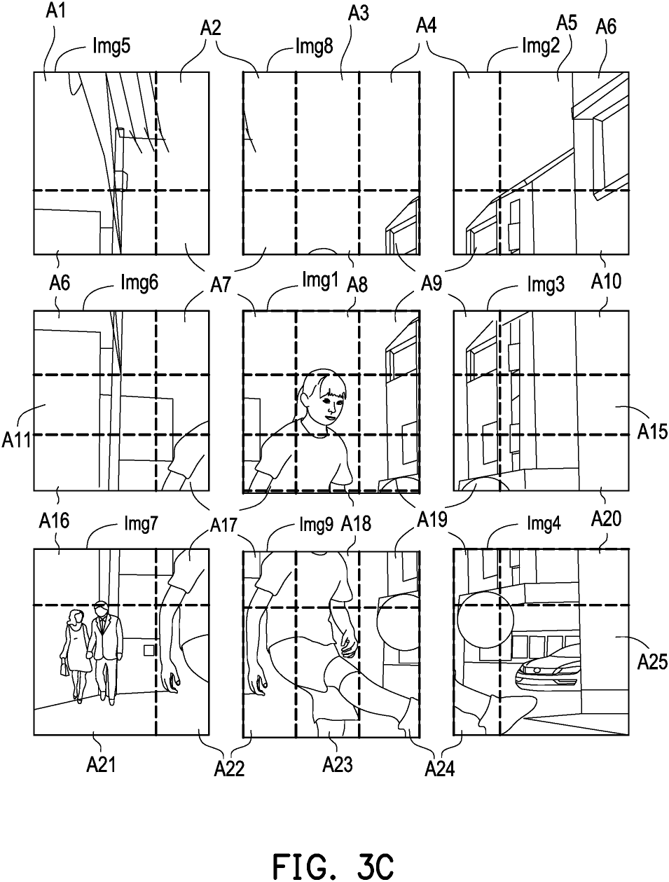

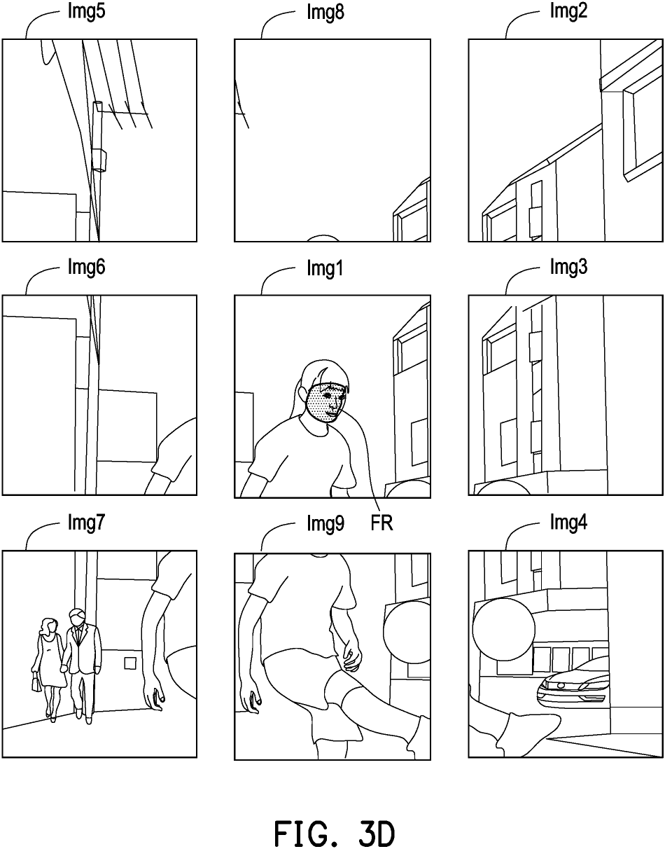

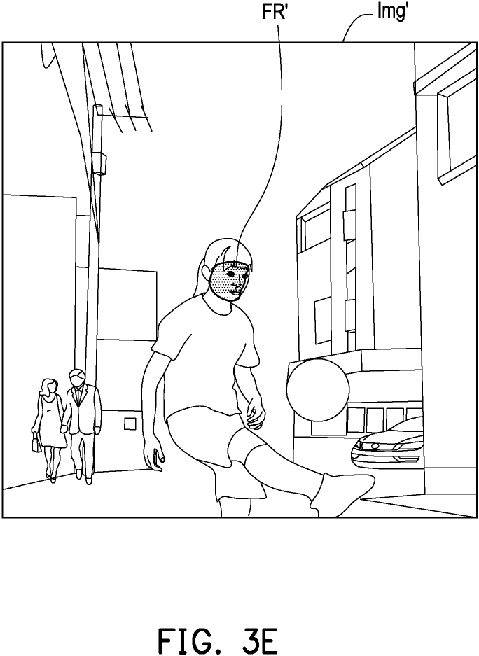

FIG. 3A to FIG. 3E are schematic diagrams illustrating implementation of image cutting to recognize a far user according to an exemplary embodiment of the disclosure. With reference to FIG. 3A and FIG. 3B first, the processing device 140 temporarily divides a user image Img into a plurality of temporary image blocks A1 to A20 through temporary cutting lines cut1 to cut8. Next, the processing device 140 cuts the user image Img into a plurality of images to be recognized based on the temporary image blocks A1 to A20. Herein, the images to be recognized include one central image to be recognized and a plurality of peripheral images to be recognized.

For instance, as shown in FIG. 3B and FIG. 3C, the processing device 140 cuts out a central image to be recognized Img1 based on the temporary image blocks A7, A8, A9, A12, A13, A14, A17, A18, and A19. The processing device 140 cuts out a peripheral image to be recognized Img2 based on the temporary image blocks A4, A5, A9, and A10. The processing device 140 cuts out a peripheral image to be recognized Img3 based on the temporary image blocks A9, A10, A14, A15, A19, and A20. The processing device 140 cuts out a peripheral image to be recognized Img4 based on the temporary image blocks A9, A20, A24, and A25. The processing device 140 cuts out a peripheral image to be recognized Img5 based on the temporary image blocks A1, A2, A6, and A7. The processing device 140 cuts out a peripheral image to be recognized Img6 based on the temporary image blocks A6, A7, A11, A12, A16, and A17. The processing device 140 cuts out a peripheral image to be recognized Img7 based on the temporary image blocks A16, A17, A21, and A22. The processing device 140 cuts out a peripheral image to be recognized Img8 based on the temporary image blocks A2, A3, A4, A7, A8, and A9. The processing device 140 cuts out a peripheral image to be recognized Img9 based on the temporary image blocks A17, A18, A19, A22, A23, and A24.

Taking the central image to be recognized Img1 as an example, the images to be recognized that are vertically adjacent to the central image to be recognized Img1 are the peripheral image to be recognized Img8 and the peripheral image to be recognized Img9. An overlapping region, including the temporary image blocks A7, A8, and A9, is present between the central image to be recognized Img1 and the peripheral image to be recognized Img8. An overlapping region, including the temporary image blocks A17, A18, and A19, is present between the central image to be recognized Img1 and the peripheral image to be recognized Img9 as well.

The images to be recognized that are horizontally adjacent to the central image to be recognized Img1 are the peripheral image to be recognized Img3 and the peripheral image to be recognized Img6. An overlapping region, including the temporary image blocks A9, A14, and A19, is present between the central image to be recognized Img1 and the peripheral image to be recognized Img3 that are horizontally adjacent to each other. An overlapping region, including the temporary image blocks A7, A12, and A17, is present between the central image to be recognized Img1 and the peripheral image to be recognized Img6 that are horizontally adjacent to each other.

The images to be recognized that are diagonally adjacent to the central image to be recognized Img1 are the peripheral image to be recognized Img2, the peripheral image to be recognized Img4, the peripheral image to be recognized Img5, and the peripheral image to be recognized Img7. An overlapping region, including the temporary image block A9, is present between the central image to be recognized Img1 and the peripheral image to be recognized Img2 that are diagonally adjacent to each other.

Besides, the peripheral image to be recognized Img5 and the peripheral image to be recognized Img6 are images to be recognized that are vertically adjacent to each other, for example, and an overlapping region, including the temporary image blocks A6 and A7, is present between the two as well. For instance, the peripheral image to be recognized Img5 and the peripheral image to be recognized Img8 are images to be recognized that are horizontally adjacent to each other, and an overlapping region, including the temporary image blocks A2 and A7, is present between the two as well.

After the processing device 140 cuts the user image Img into the central image to be recognized Img1 and the peripheral images to be recognized Img2 to Img9, the user image capturing device 130 then performs face recognition on each of the central image to be recognized Img1 and the peripheral images to be recognized Img2 to Img9. As shown in FIG. 3D, the processing device 140 recognizes the user’s face in the central image to be recognized Img1 and generates a recognition result FR. After the processing device 140 performs face recognition on each of the images to be recognized and obtains a recognition result corresponding to each of the images to be recognized, as shown in FIG. 3E, the processing device 140 combines the central image to be recognized Img1 and the peripheral images to be recognized Img2 to Img9 into a recognized user image Img′ and recognizes the spatial position information of the far user FarUser according to a recognition result FR′.

In an embodiment, the database 150 stores a plurality of object feature points corresponding to each dynamic object Obj. After the processing device 140 recognizes the target object TarObj watched by the service user SerUser according to the line of sight S1 of the service user SerUser, the processing device 140 captures a pixel feature of the target object TarObj and compares the pixel feature with the object feature points. If the pixel feature matches the object feature points, the processing device 140 generates a number corresponding to the target object TarObj, position three-dimensional coordinates (xₒ, yₒ, zₒ) corresponding to the target object TarObj, and depth and width information (wₒ, hₒ) of the target object TarObj.

The processing device 140 can determine a display position where the virtual information Vinfo is displayed on the display device 110 according to the spatial position information of the service user SerUser and the spatial position information of the target object TarObj. To be specific, the processing device 140 calculates a cross-point position CP where the line of sight S1 of the service user SerUser passes through the display device 110 and displays the virtual information Vinfo corresponding to the target object TarObj on the cross-point position CP of the display device 110 according to the face position three-dimensional coordinates (xᵤ, yᵤ, zᵤ) of the service user SerUser, the position three-dimensional coordinates (xₒ, yₒ, zₒ) of the target object TarObj, and the depth and width information (hₒ, wₒ). In FIG. 2, the virtual information Vinfo may be displayed in a display object frame Vf, and a central point of the display object frame Vf is the cross-point position CP.

To be specific, the display position where the virtual information Vinfo is displayed may be treated as a landing point or an area where the line of sight S1 passes through the display device 110 when the service user SerUser views the target object TarObj. As such, the processing device 140 may display the virtual information Vinfo at the cross-point position CP through the display object frame Vf. More specifically, based on various needs or different applications, the processing device 140 may determine the actual display position of the virtual information Vinfo, so that the service user SerUser may see the virtual information Vinfo superimposed on the target object TarObj through the display device 110. The virtual information Vinfo may be treated as the augmented reality content which is amplified based on the target object TarObj.

Besides, the processing device 140 may also determine whether the virtual information Vinfo corresponding to the target object TarObj is superimpose and displayed on the cross-point position CP of the display device 110. If the processing device 140 determines that the virtual information Vinfo is not superimposed and displayed on the cross-point position CP of the display device 110, the processing device 140 performs offset correction on the position of the virtual information Vinfo. For instance, the processing device 140 may perform offset correction on the position of the virtual information Vinfo by using the information offset correction equation to optimize the actual display position of the virtual information Vinfo.

As described in the foregoing paragraphs, after recognizing the user User and selecting the service user SerUser in the user image, the processing device 140 captures the facial feature of the service user SerUser, determines whether the facial feature matches the plurality of facial feature points, calculates the face position of the service user SerUser and the line of sight direction of the line of sight S1 by using the facial feature points, and generates the number (ID) corresponding to the service user SerUser and the face position three-dimensional coordinates (xᵤ, yᵤ, zᵤ).

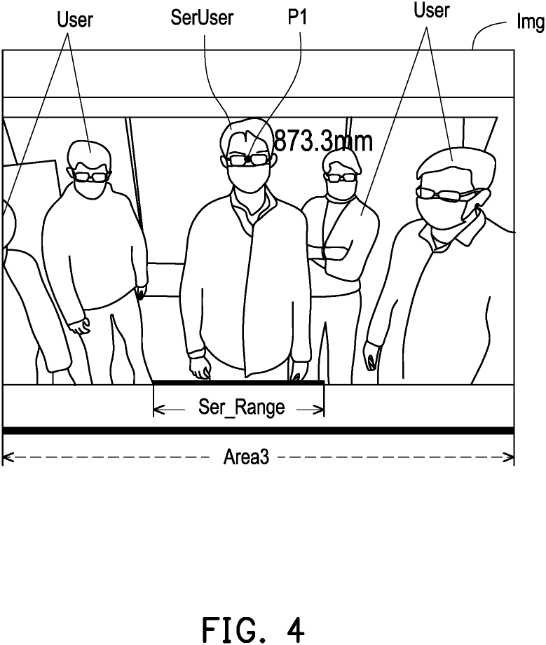

When a plurality of users User are in the service area Area3, the processing device 140 recognizes the at least one user in the user image and selects the service user SerUser from the plurality of users User in the service area Area3 through a user filtering mechanism. FIG. 4 is a schematic diagram of selection of the service user SerUser by the active interactive navigation system according to an exemplary embodiment of the disclosure. The processing device 140 can filter out the users outside the service area Area3 and select the service user SerUser from the users User in the service area Area3. In an embodiment, according to the positions and distances of the users User, the user User who is closer to the user image capturing device 130 may be selected as the service user SerUser. In another embodiment, according to the positions of the users User, the user User who is closer to the center of the user image capturing device 130 may be selected as the service user SerUser. In another embodiment, alternatively, as shown in FIG. 4, according to the left-right relationship of the users User, the user User who is relatively in the middle may be selected as the service user SerUser.

Once the processing device 140 recognizes the user User from the user image Img and selects the service user SerUser, a service area range Ser_Range is displayed at the bottom of the user image Img, the face of the service user SerUser on the user image Img is marked with a focal point P1, and the distance between the service user SerUser and the user image capturing device 130 (e.g., 873.3 mm) is displayed. Herein, the user image capturing device 130 may first filter out other users User, so as to accurately focus on the service user SerUser.

After selecting the service user SerUser in the user image Img, the processing device 140 captures the facial feature of the service user SerUser, calculates the face position of the service user SerUser and the line of sight direction of the line of sight S1 by using the facial feature points, and generates the number (ID) corresponding to the service user SerUser and the face position three-dimensional coordinates (xᵤ, yᵤ, zᵤ). The position of the focus point P1 may be located at the face position three-dimensional coordinates (xᵤ, yᵤ, zᵤ) of the service user SerUser. Besides, the processing device 140 also generates face depth information (hₒ) according to the distance between the service user SerUser and the user image capturing device 130.

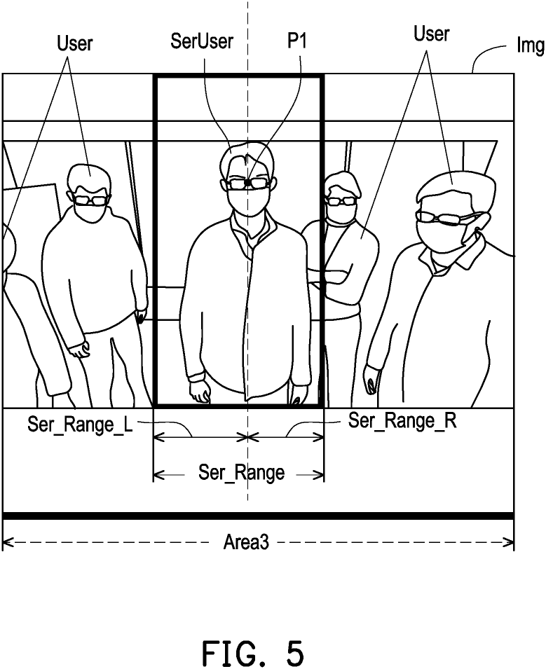

When the service user SerUser moves left and right within the range of the service area Area3, the processing device 140 treats the horizontal coordinate xᵤ in the face position three-dimensional coordinates (xᵤ, yᵤ, zᵤ) of the service user SerUser as the central point and dynamically translates the service area range Ser_Range according to the position of the serve user SerUser. FIG. 5 is a schematic diagram illustrating adjustment of the service area range Ser_Range according to an exemplary embodiment of the disclosure. With reference to FIG. 5, when the service user SerUser moves left and right within the range of the service area Area3, the service area range Ser_ Range dynamically translates left and right with the face position (focal point P1) of the service user SerUser as the central point, but dimensions of the service area range Ser_Range may remain unchanged.

The service area range Ser_ Range may have initial dimensions (e.g., 60 cm) or variable dimensions. When the service user SerUser moves back and forth within the range of the service area Area3, as the distance between the service user SerUser and the user image capturing device 130 changes, the dimensions of the service area range Ser_Range may also be appropriately adjusted. As shown in FIG. 5, the processing device 140 treats the face position (focal point P1) of the service user SerUser as the central point and adjusts left and right dimensions of the service area range Ser_ Range according to the face depth information (hₒ) of the service user SerUser, that is, adjusts a left range Ser_Range_L and a right range Ser_Range_R of the service area range Ser Range.

In an embodiment, the processing device 140 may calculate the left range Ser_Range_L and the right range Ser_Range_R of the service area range Ser_ Range according to the face depth information (hₒ) as follows:

$$\begin{matrix}\text{Ser\_Range\_L,} \text{Ser\_Range\_R} = \\ \frac{s e r v i c e a r e a r a n g e i n i t i a l d i m e n s i o n s \times w i d t h}{4 \times {h}_{0} \times tan \frac{F O {V}_{w}}{2}}\end{matrix}$$

Herein, width refers to the width value of the camera resolution, for example, if the camera resolution is 1,280×720, the width is 1,280, and if the camera resolution is 1,920×1,080, the width is then 1,920. FOVW is the field of view width of the user image capturing device 130.

Once the service user SerUser leaves the range of the service area Area3, the processing device 140 cannot detect the serve user SerUser in the service area range Ser Range. In an embodiment, the user image capturing device 130 may reset the dimensions of the service area range Ser_Range and move the service area range Ser_Range to an initial position, such as the center of the bottom. Regarding the movement to the initial position, the service area range Ser_Range may be moved to the initial position gradually and slowly or may be moved to the initial position immediately. In another embodiment, the processing device 140 may not move the service area range Ser_Range to the initial position, but select the next service user SerUser instead from the plurality of users User in the service area Area3 through the user filtering mechanism. After selecting the next service user SerUser, the processing device 140 then treats the horizontal coordinate xᵤ in the face position three-dimensional coordinates (xᵤ, yᵤ, zᵤ) of the service user SerUser as the central point and dynamically translates the service area range Ser_Range according to the position of the next serve user SerUser.

In an embodiment, the disclosure further provides an active interactive navigation system. In the system, the service user may be selected from a plurality of users in the service area through the user filtering mechanism. Further, the target object watched by the service user is recognized according to the line of sight of the service user, and the virtual information corresponding to the target object is displayed on the cross-point position of the display device. With reference to FIG. 1 and FIG. 2 again, the active interactive navigation system 1 includes the light-transmittable display device 110, the target object image capturing device 120, the user image capturing device 130, and the processing device 140. The light-transmittable display device 110 is disposed between the at least one user User and a plurality of dynamic objects Obj. The target object image capturing device 120 is coupled to the display device 110 and is configured to obtain a dynamic object image of the dynamic objects Obj. The user image capturing device 130 is coupled to the display device 110 and is configured to obtain the user image of the user User.

The processing device 140 is coupled to the display device 110. The processing device 140 is configured to recognize the dynamic objects Obj in the dynamic object image and tracks the dynamic objects Obj. The processing device is further configured to recognize the at least one user User in the user image, selects the service user SerUser according to the range of the service area Area3, and detects the line of sight S1 of the service user SerUser. The range of the service area Area3 has initial dimensions, and the line of sight S1 of the service user SerUser passes through the display device 110 to watch the target object TarObj among the dynamic objects Obj. Herein, the processing device 140 is further configured to recognize the target object TarObj watched by the service user SerUser according to the line of sight S1 of the service user SerUser, generate the face position three-dimensional coordinates (xᵤ, yᵤ, zᵤ) corresponding to the service user SerUser, the position three-dimensional coordinates corresponding to the target object TarObj, and the depth and width information (hₒ, wₒ) of the target object, accordingly calculate the cross-point position CP where the line of sight S1 of the service user SerUser passes through the display device 110, and display the virtual information Vinfo corresponding to the target object TarObj on the cross-point position CP of the display device 110. The description of the implementation is provided in detail in the foregoing paragraphs and is not repeated herein.

In an embodiment, when the service user SerUser moves, the processing device 140 dynamically adjusts the left and right dimensions of the range of the service area Area3 with the face position three-dimensional coordinates (xᵤ, yᵤ, zᵤ) of the service user SerUser as the central point.

In an embodiment, when the processing device 140 does not recognize the service user SerUser in the range of the service area Area3 in the user image, the processing device 140 resets the range of the service area Area3 to the initial dimensions.

In the disclosure, each of the target object image capturing device 120, the user image capturing device 130, and the processing device 140 is programed by a program code to perform parallel computing separately and to perform parallel processing by using multi-threading with a multi-core central processing unit.

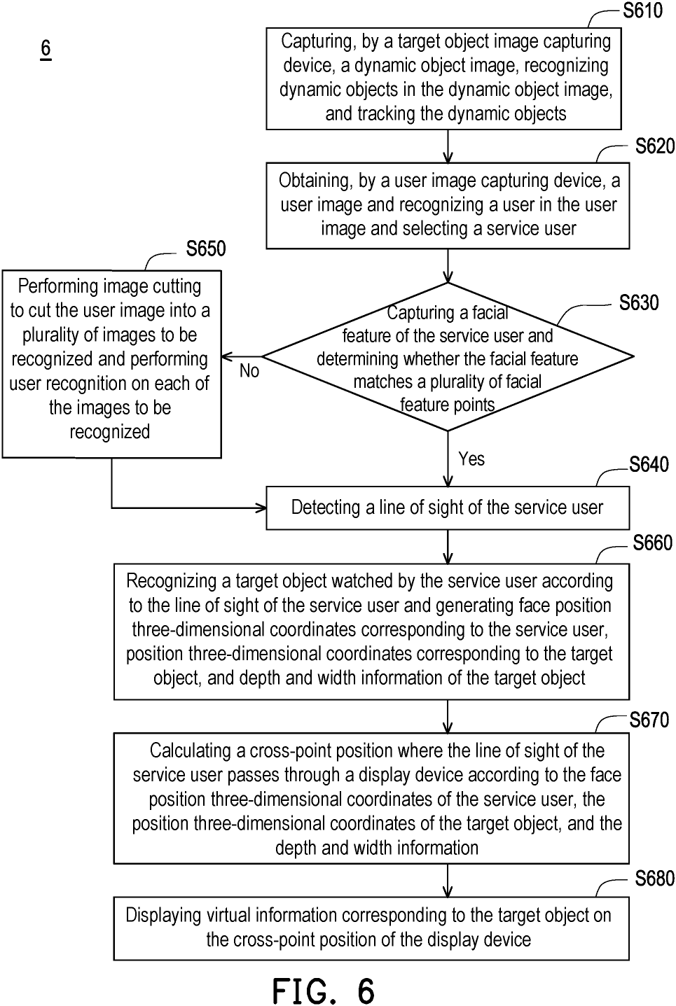

FIG. 6 is a flow chart illustrating an active interactive navigation method 6 according to an exemplary embodiment of the disclosure. With reference to FIG. 1, FIG. 2, and FIG. 6 together, the process flow of the active interactive navigation method 6 provided in FIG. 6 can be achieved by the active interactive navigation system 1 shown in FIG. 1 and FIG. 2. Herein, the user User (service user SerUser) may view the dynamic objects Obj, the target object TarObj, and the corresponding virtual information VInfo through the display device 110 of the active interactive navigation system 1.

In step S610, the target object image capturing device 120 obtains the dynamic object image, recognizes the dynamic objects Obj in the dynamic object image, and tracks the dynamic objects Obj. In step S620, the user image capturing device 130 obtains the user image and recognizes and selects the service user SerUser in the user image. As described above, each of the target object image capturing device 120 and the user image capturing device 130 may include an RGB image sensing module, a depth sensing module, an inertial sensing module, and a GPS positioning sensing module and may perform positioning on the positions of the user User, the service user SerUser, the dynamic objects Obj, as well as the target object TarObj.

In step S630, the facial feature of the service user SerUser is captured, and it is determined whether the facial feature matches a plurality of facial feature points. If the facial feature matches the facial feature points, in step S640, the line of sight S1 of the service user SerUser is then detected. If the facial feature does not match the facial feature points, in step S650, image cutting is then performed to cut the user image into a plurality of images to be recognized. User recognition is separately performed on each of the images to be recognized until the facial feature of the service user SerUser in at least one of the images to be recognized matches the facial feature points, and in step S640, the line of sight S1 of the service user SerUser is then detected. The line of sight S1 passes through the display device 110 to watch the target obj ect TarObj among the dynamic objects Obj.

After the line of sight S1 of the service user SerUser is detected, next, in step S660, according to the line of sight S1 of the service user SerUser, the target object TarObj watched by the service user SerUser is recognized, the face position three-dimensional coordinates (xᵤ, yᵤ, zᵤ) corresponding to the service user SerUser, the position three-dimensional coordinates (xₒ, yₒ, zₒ) corresponding to the target object TarObj, and the depth and width information (hₒ, wₒ) of the target object TarObj are generated. In step S670, the cross-point position CP where the line of sight S1 of the service user SerUser passes through the display device 110 is calculated according to the face position three-dimensional coordinates (xᵤ, yᵤ, zᵤ) of the service user SerUser, the position three-dimensional coordinates (xₒ, yₒ, zₒ) of the target object TarObj, and the depth and width information (hₒ, wₒ). In step S680, the virtual information Vinfo corresponding to the target object TarObj is displayed on the cross-point position CP of the display device 110.

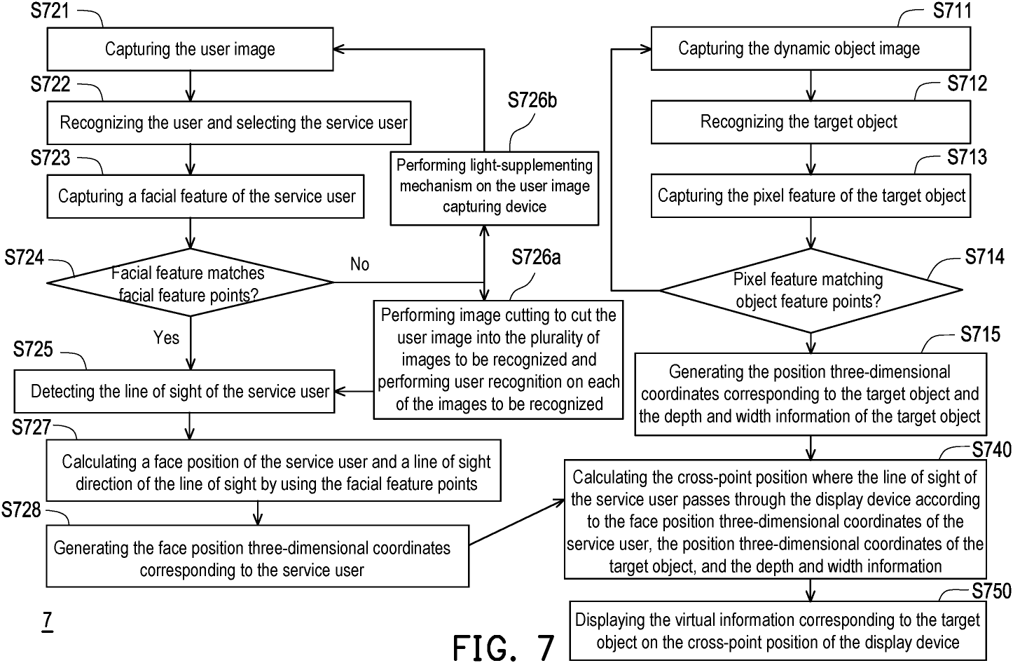

FIG. 7 is a flow chart illustrating an active interactive navigation method 7 according to an exemplary embodiment of the disclosure and mainly further illustrates steps S610 to 660 in the active interactive navigation method 6 shown in FIG. 6. With reference to FIG. 2 and FIG. 7, In step S711, the target object image capturing device 120 captures the dynamic object image. In step S712, the target object TarObj watched by the service user SerUser is recognized according to the line of sight S1 of the service user SerUser. In step S713, the pixel feature of the target object TarObj is captured. In step S714, the pixel feature is compared to the object feature points stored in the database 150 corresponding to each one of the dynamic objects Obj. If the pixel feature does not match the object feature points stored in the database 150, step S711 is performed again to keep on capturing the dynamic object image. If the pixel feature matches the object feature points, in step S715, the number corresponding to the target object TarObj, the position three-dimensional coordinates (xₒ, yₒ, zₒ) corresponding to the target object TarObj, and the depth and width information (wₒ, hₒ) of the target object TarObj are generated.

On the other hand, in step S721, the user image capturing device 130 captures the user image. In step S722, the user User is recognized, and the service user SerUser is selected. In step S723, the facial feature of the service user SerUser is captured. In step S724, it is determined whether the facial feature of the service user SerUser matches the facial feature points. If the facial feature of the service user SerUser matches the facial feature points stored in the database 150, in step S725, the line of sight S1 of the service user SerUser is then detected.

If the facial feature of the service user SerUser does not match the facial feature points stored in the database 150, on the one hand, in step S726a, image cutting is performed to cut the user image into a plurality of images to be recognized. User recognition is separately performed on each of the images to be recognized until the facial feature of the service user SerUser in at least one of the images to be recognized matches the facial feature points, and in step S725, the line of sight S1 of the service user SerUser is then detected. On the other hand, in step S726b, the light-supplementing mechanism is performed on the user image capturing device 130 to improve the clarity of the user image.

After the line of sight S1 of the service user SerUser is detected, next, in step S727, the face position of the service user SerUser and the line of sight direction of the line of sight S1 are calculated by using the facial feature points. In step S728, the number (ID) and the face position three-dimensional coordinates (xᵤ, yᵤ, zᵤ) corresponding to the service user SerUser are generated.

After the number of the target object TarObj, the position three-dimensional coordinates (xₒ, yₒ, zₒ) corresponding to the target object TarObj, the depth and width information (wₒ, hₒ) of the target object TarObj, the number (ID) corresponding to the service user SerUser, and the face position three-dimensional coordinates (xᵤ, yᵤ, zᵤ) are all generated, in step S740, the cross-point position CP where the line of sight S1 of the service user SerUser passes through the display device 110 is calculated according to the face position three-dimensional coordinates (xᵤ, yᵤ, zᵤ) of the service user SerUser, the position three-dimensional coordinates (xₒ, yₒ, zₒ) of the target object TarObj, and the depth and width information (hₒ, wₒ). In step S750, the virtual information Vinfo corresponding to the target object TarObj is displayed on the cross-point position CP of the display device 110.

In an embodiment, in the active interactive navigation method provided by the disclosure, it is determined whether the virtual information Vinfo corresponding to the target object TarObj is superimposed and displayed on the cross-point position CP of the display device 110. If it is determined that the virtual information Vinfo is not superimposed nor displayed on the cross-point position CP of the display device 110, offset correction may be performed on the position of the virtual information Vinfo through the information offset correction formula.

If the proportion of the service user SerUser in the user image is excessively small, the facial feature of the service user SerUser cannot be captured. Further, when the facial feature points are used to calculate the face position and the line of sight direction of the line of sight S1 of the service user SerUser, in the active interactive navigation method provided by the disclosure, the user image can be cut into the plurality of images to be recognized first. The images to be recognized include the central image to be recognized and the plurality of peripheral images to be recognized. An overlapping region is present between one of the images to be recognized and another adjacent one. The one of the images to be recognized and the another adjacent one are vertically, horizontally, or diagonally adjacent to each other. The description of the implementation is provided in detail in the foregoing paragraphs and is not repeated herein.

When a plurality of users User are in the service area Area3, in the active interactive navigation method provided by the disclosure, the processing device 140 may recognize the at least one user in the user image and select the service user SerUser from the plurality of users User in the service area Area3 through the user filtering mechanism. Once the user User from the user image Img is recognized and the service user SerUser is selected, the service area range Ser_Range is displayed at the bottom of the user image Img, so that the service user SerUser is precisely focused. The service area range Ser_Range may have initial dimensions or variable dimensions.

After the service user SerUser in the user image Img is selected, the facial feature of the service user SerUser is captured, the face position of the service user SerUser and the line of sight direction of the line of sight are calculated by using the facial feature points, and the number (ID) corresponding to the service user SerUser and the face position three-dimensional coordinates (xᵤ, yᵤ, zᵤ) are generated. The position of the focus point P1 may be located at the face position three-dimensional coordinates (xᵤ, yᵤ, zᵤ) of the service user SerUser. Besides, the face depth information (hₒ) is also generated according to the distance between the service user SerUser and the user image capturing device 130.

When the service user SerUser moves left and right within the range of the service area Area3, in the active interactive navigation method provided by the disclosure, the horizontal coordinate xᵤ in the face position three-dimensional coordinates (xᵤ, yᵤ, zᵤ) of the service user SerUser is treated as the central point, and the service area range Ser_Range is dynamically translated according to the position of the serve user SerUser. When the service user SerUser moves left and right within the range of the service area Area3, the service area range Ser_Range dynamically translates left and right with the face position (focal point P1) of the service user SerUser as the central point, but dimensions of the service area range Ser_ Range may remain unchanged.

When the service user SerUser moves back and forth within the range of the service area Area3, as the distance between the service user SerUser and the user image capturing device 130 changes, the dimensions of the service area range Ser_Range may also be appropriately adjusted. The description of the implementation is provided in detail in the foregoing paragraphs and is not repeated herein.

In view of the foregoing, in the active interactive navigation system and the active interactive navigation method provided by the embodiments of the disclosure, the line of sight direction of the user is tracked and viewed at real time, the moving target object is stably tracked, and the virtual information corresponding to the target object is actively displayed. In this way, high-precision augmented reality information and a comfortable non-contact interactive experience are provided. In the embodiments of the disclosure, internal and external perception recognition, virtual-reality fusion, and system virtual-reality fusion may also be integrated to match the calculation core. The angle of the tourist’s line of sight is actively recognized by the inner perception and is then recognized with the AI target object of outer perception, and the application of augmented reality is thus achieved. In addition, in the embodiments of the disclosure, the algorithm for correcting the display position in virtual-reality fusion is optimized for the implementation of the offset correction method, so that the face recognition of far users is improved, and the priority of the service users is filtered. In this way, the problem of manpower shortage can be solved, and an interactive experience of zero-distance transmission of knowledge and information can be created.

What is claimed is:

1. An active interactive navigation system, comprising:
a light-transmittable display device, disposed between at least one user and a plurality of dynamic objects;
a target object image capturing device, coupled to the display device, configured to obtain a dynamic object image;
a user image capturing device, coupled to the display device, configured to obtain a user image; and
a processing device, coupled to the display device, configured to recognize the dynamic objects in the dynamic object image, track the dynamic objects, recognize the at least one user and select a service user in the user image, capture a facial feature of the service user, determine whether the facial feature matches a plurality of facial feature points, detect a line of sight of the service user if the facial feature matches the facial feature points, perform image cutting to cut the user image into a plurality of images to be recognized if the facial feature does not match the facial feature points, and perform user recognition on each of the images to be recognized to detect the line of sight of the service user, wherein the line of sight passes through the display device to watch a target object among the dynamic objects,
wherein the processing device is further configured to recognize the target object watched by the service user according to the line of sight, generate face position three-dimensional coordinates corresponding to the service user, position three-dimensional coordinates corresponding to the target object, and depth and width information of the target object, accordingly calculate a cross-point position where the line of sight passes through the display device, and display virtual information corresponding to the target object on the cross-point position of the display device.

2. The active interactive navigation system according to claim 1, wherein the images to be recognized comprise a central image to be recognized and a plurality of peripheral images to be recognized.

3. The active interactive navigation system according to claim 1, wherein an overlapping region is present between one of the images to be recognized and another adjacent one.

4. The active interactive navigation system according to claim 3, wherein the one of the images to be recognized and the another adjacent one are vertically, horizontally, or diagonally adjacent to each other.

5. The active interactive navigation system according to claim 1, wherein each of the target object image capturing device, the user image capturing device, and the processing device is programed by a program code to perform parallel computing separately and to perform parallel processing by using multi-threading with a multi-core central processing unit.

6. The active interactive navigation system according to claim 1, wherein the user image capturing device comprises an RGB image sensing module, a depth sensing module, an inertial sensing module, and a GPS positioning sensing module.

7. The active interactive navigation system according to claim 1, wherein if the facial feature matches the facial feature points, the processing device calculates a face position of the service user by using the facial feature points and a line of sight direction of the line of sight and generates a number corresponding to the service user and the face position three-dimensional coordinates.

8. The active interactive navigation system according to claim 7, wherein the processing device recognizes the at least one user in the user image and selects the service user according to a service area range, wherein the service area range has initial dimensions.

9. The active interactive navigation system according to claim 8, wherein when the service user moves, the processing device dynamically adjusts left and right dimensions of the service area range with the face position three-dimensional coordinates of the service user as a central point.

10. The active interactive navigation system according to claim 9, wherein when the processing device does not recognize the service user in the service area range in the user image, the processing device resets the service area range to the initial dimensions.

11. The active interactive navigation system according to claim 1, further comprising:
a database, coupled to the processing device, configured to store a plurality of object feature points corresponding to each one of the dynamic objects,
wherein after the processing device recognizes the target object watched by the service user, the processing device captures a pixel feature of the target object and compares the pixel feature with the object feature points, and
if the pixel feature matches the object feature points, the processing device generates a number corresponding to the target object, the position three-dimensional coordinates corresponding to the target object, and the depth and width information of the target object.

12. The active interactive navigation system according to claim 1, wherein the processing device determines whether the virtual information corresponding to the target object is superimposed and displayed on the cross-point position of the display device, and
if the virtual information is not superimposed nor displayed on the cross-point position of the display device, the processing device performs offset correction on a position of the virtual information.

13. An active interactive navigation method adapted to an active interactive navigation system comprising a light-transmittable display device, a target object image capturing device, a user image capturing device, and a processing device, wherein the display device is disposed between at least one user and a plurality of dynamic objects, the processing device is configured to execute the active interactive navigation method, and the active interactive navigation method comprises:
capturing, by the target object image capturing device, a dynamic object image, recognizing the dynamic objects in the dynamic object image, and tracking the dynamic objects;
obtaining, by the user image capturing device, a user image, recognizing the at least one user in the user image and selecting a service user, capturing a facial feature of the service user and determining whether the facial feature matches a plurality of facial feature points, detecting a line of sight of the service user if the facial feature matches the facial feature points, performing image cutting to cut the user image into a plurality of images to be recognized if the facial feature does not match the facial feature points, and performing user recognition on each of the images to be recognized to detect the line of sight of the service user, wherein the line of sight passes through the display device to watch a target object among the dynamic objects; and
recognizing the target object watched by the service user according to the line of sight, generating face position three-dimensional coordinates corresponding to the service user, position three-dimensional coordinates corresponding to the target object, and depth and width information of the target object, accordingly calculating a cross-point position where the line of sight passes through the display device, and displaying virtual information corresponding to the target object on the cross-point position of the display device.

14. The active interactive navigation method according to claim 13, wherein the images to be recognized comprise a central image to be recognized and a plurality of peripheral images to be recognized.

15. The active interactive navigation method according to claim 13, wherein an overlapping region is present between one of the images to be recognized and another adjacent one.

16. The active interactive navigation method according to claim 15, wherein the one of the images to be recognized and the another adjacent one are vertically, horizontally, or diagonally adjacent to each other.

17. The active interactive navigation method according to claim 13, further comprising:
calculating a face position of the service user by using the facial feature points and a line of sight direction of the line of sight if the facial feature matches the facial feature points; and
generating a number and the face position three-dimensional coordinates corresponding to the service user.

18. The active interactive navigation method according to claim 17, wherein the step of obtaining, by the user image capturing device, the user image and recognizing the at least one user in the user image and selecting the service user further comprises:
recognizing the at least one user in the user image and selecting the service user according to a service area range, wherein the service area range has initial dimensions.

19. The active interactive navigation method according to claim 18, further comprising:
dynamically adjusting left and right dimensions of the service area range with the face position three-dimensional coordinates of the service user as a central point when the service user moves.

20. The active interactive navigation method according to claim 19, further comprising:
resetting the service area range to the initial dimensions when the service user is not recognized in the service area range in the user image.

21. The active interactive navigation method according to claim 13, further comprising:
capturing a pixel feature of the target object and comparing the pixel feature with the object feature points after recognizing the target object watched by the service user; and
generating a number corresponding to the target object, the position three-dimensional coordinates corresponding to the target object, and the depth and width information of the target object if the pixel feature matches the object feature points.

22. The active interactive navigation method according to claim 13, further comprising:
determining whether the virtual information corresponding to the target object is superimposed and displayed on the cross-point position of the display device; and
performing offset correction on a position of the virtual information if the virtual information is not superimposed nor displayed on the cross-point position of the display device.

23. An active interactive navigation system, comprising:
a light-transmittable display device, disposed between at least one user and a plurality of dynamic objects;
a target object image capturing device, coupled to the display device, configured to obtain a dynamic object image;
a user image capturing device, coupled to the display device, configured to obtain a user image; and
a processing device, coupled to the display device, configured to recognize the dynamic objects in the dynamic object image, track the dynamic objects, recognize the at least one user in the user image, select a service user according to a service area range, and detect a line of sight of the service user, wherein the service area range has initial dimensions, and the line of sight passes through the display device to watch a target object among the dynamic objects,
wherein the processing device is further configured to recognize the target object watched by the service user according to the line of sight, generate face position three-dimensional coordinates corresponding to the service user, position three-dimensional coordinates corresponding to the target object, and depth and width information of the target object, accordingly calculate a cross-point position where the line of sight passes through the display device, and display virtual information corresponding to the target object on the cross-point position of the display device.

24. The active interactive navigation system according to claim 23, wherein when the service user moves, the processing device dynamically adjusts left and right dimensions of the service area range with the face position three-dimensional coordinates of the service user as a central point.

25. The active interactive navigation system according to claim 24, wherein when the processing device does not recognize the service user in the service area range in the user image, the processing device resets the service area range to the initial dimensions.
